(19) United States
(12) Patent Application Publication
(10) Pub. No.: US 2026/0050737 A1
(43) Pub. Date: Feb. 19, 2026

(54) GENERATION OF CANDIDATE WORDS FOR DETECTION OF TEXT DATA GENERATED BY AN ARTIFICAL INTELLIGENCE MODEL

(71) Applicant: International Business Machines Corporation, Armonk, NY (US)

(72) Inventors: RAN KIMURA, Kanagawa (JP); HIROSHI KANAYAMA, Yokohama-shi (JP)

(21) Appl. No.: 18/802,019

(22) Filed: Aug. 13, 2024

(51) Int. Cl. G06F 40/284

(52) U.S. Cl. CPC G06F 40/284

(57) ABSTRACT

Generation of candidate words for detection of text data generated by an artificial intelligence (AI) model includes obtaining a plurality of character codes associated with a plurality of characters. The plurality of characters is associated with a plurality of words. Based on the plurality of character codes, a first set of candidate words is generated. Each candidate word of the first set of candidate words comprises a combination of at least two character codes of the plurality of character codes. Further, based on an application of a set of predefined criteria on the first set of candidate words, a second set of candidate words is generated. The set of predefined criteria is associated with a likelihood of generation of each of the first set of candidate words by the AI model. The second set of candidate words is output for detecting the text data generated by the AI model.

### BACKGROUND

The disclosure relates to text processing and more particularly, to generation of candidate words for detection of text data generated by an artificial intelligence (AI) model.

With the advancement of natural language processing technologies, AI models have gained prominence for their ability to perform various tasks associated with language understanding and generation. Various tasks include natural language generation, text generation, translation, summarization, and user interaction. In an example, a large language model (LLM) is a type of AI model specifically trained to understand, generate, and manipulate human language on a large scale. The LLM can utilize machine learning techniques to process and comprehend natural language. The LLM can be trained by using a large number of parameters, often ranging from tens of millions to billions. The large parameter count allows the LLM to capture complex language patterns and relationships during training. In an example, the LLM may be implemented using Generative Pre-trained Transformers (GPT), Bidirectional Encoder Representation from Transformers (BERT), and the like. Additionally, due to increased accessibility of the AI models and increased demand for AI generated content, a volume of AI data generated by the AI models has increased. The AI data includes text data (such as articles, research papers, and reports), audio data (conversations, speech commands, and songs), video data (such as one or more videos), image data (such as one or more images), and interactive data (such as graphics interchange formats).

However, the AI models can generate persuasive but false text data, leading to a distribution of the false text data, intentionally or unintentionally. In an example, the false text data includes false historical text associated with historical events, false scientific text associated with scientific discoveries, and false regulation text associated with laws and regulations. Further, the AI models can generate outdated text data that is updated over a period of time. In an example, the outdated text data includes an outdated scientific text associated with the scientific discoveries and an outdated health recommendation associated with health information. Additionally, training of one or more machine learning (ML) models on the false text data or the outdated text data can lead to a decrease in accuracy of an output of the one or more ML models. For example, one or more ML models can generate inaccurate recommendations based on the false text data or the outdated text data. Further, redundant text data generated by the AI models may introduce bias in the training of the one or more ML models, leading to a decrease in a performance of the one or more ML model. Hence, there is a need to mitigate the aforementioned challenges associated with the performance of the AI models.

### SUMMARY

According to an embodiment of the disclosure, a computer-implemented method for generation of candidate words is described. The computer-implemented method includes obtaining, by a computer, a plurality of character codes associated with a plurality of characters. The plurality of characters is associated with a plurality of words. The computer-implemented method further includes generating, by the computer, a first set of candidate words based on the plurality of character codes. Each candidate word of the first set of candidate words comprises a combination of at least two character codes of the plurality of character codes. Further, each of the at least two character codes is associated with a corresponding word from the plurality of words. The computer-implemented method further includes generating, by the computer, a second set of candidate words based on an application of a set of predefined criteria on the first set of candidate words. The set of predefined criteria is associated with a likelihood of generation of each of the first set of candidate words by an artificial intelligence (AI) model. The computer-implemented method further includes outputting, by the computer, the second set of candidate words for detecting text data generated by the AI model.

According to an embodiment of the disclosure, a system for generation of candidate words is described. The system comprises a processor set configured to receive the text data. Further, the processor set is configured to obtain a plurality of characters code associated with a plurality of characters. The plurality of characters is associated with a plurality of words. The processor set is further configured to generate a first set of candidate words based on the plurality of characters codes. Each candidate word of the first set of candidate words comprises a combination of at least two character codes of the plurality of character codes. Further, each of the at least two character codes is associated with a corresponding word from the plurality of words. The processor set is further configured to generate a second set of candidate words based on an application of a set of predefined criteria on the first set of candidate words. The set of predefined criteria is associated with a likelihood of generation of each of the first set of candidate words by an artificial intelligence (AI) model. The processor set is further configured to identify an occurrence of at least one of the second set of candidate words in text data. The processor set is further configured to output a notification to indicate that the text data is generated by the AI model. The outputting is based on the occurrence of the at least one of the second set of candidate words in the text data.

According to an embodiment of the disclosure, a computer program product for generation of candidate words is described. The computer program product comprises a computer-readable storage medium having program instructions embodied therewith. The program instructions executable by a system to cause the system to obtain a plurality of character codes associated with a plurality of characters. The plurality of characters is associated with a plurality of words. The system is further configured to generate a first set of candidate words based on the plurality of character codes. Each candidate word of the first set of candidate words comprises a combination of at least two character codes of the plurality of character codes. Further, each of the at least two character codes is associated with a corresponding word from the plurality of words. The system is further configured to generate a second set of candidate words based on an application of a predefined criterion on each of the first set of candidate words. The predefined criterion is associated with determination of a similarity score to be greater than a similarity threshold. The similarity score is determined for each of at least a pair of words from the plurality of words associated with each of the first set of candidate words. The system is further configured to output the second set of candidate words for detecting text data generated by an artificial intelligence (AI) model.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for generation of candidate words, in accordance with an embodiment of the disclosure;

FIG. 2 is a diagram that illustrates an environment for generation of the candidate words, in accordance with an embodiment of the disclosure;

FIG. 3A is a diagram that illustrates exemplary generation of a potential candidate word based on a plurality of words, in accordance with an embodiment of the disclosure.

FIG. 3B is a diagram that illustrates exemplary generation of the potential candidate word based on a plurality of character codes, in accordance with an embodiment of the disclosure;

FIG. 3C is a flowchart of a method for generation of a first set of candidate words, in accordance with an embodiment of the disclosure;

FIG. 4 is a flowchart of a method for generation of a second set of candidate words, in accordance with an embodiment of the disclosure;

FIG. 5A is a flowchart of a method for application of a first criterion on a first candidate word, in accordance with an embodiment of the disclosure;

FIG. 5B is a flowchart of a method for application of a second criterion on the first candidate word, in accordance with an embodiment of the disclosure;

FIG. 5C is a flowchart of a method for application of a third criterion on the first candidate word, in accordance with an embodiment of the disclosure;

FIG. 6A is a flowchart of a method for application of a fourth criterion on the first candidate word, in accordance with an embodiment of the disclosure;

FIG. 6B is a flowchart of a method for application of a fifth criterion on the first candidate word, in accordance with an embodiment of the disclosure;

FIG. 6C is a flowchart of a method for application of a sixth criterion on the first candidate word, in accordance with an embodiment of the disclosure;

FIG. 7 is a flowchart of a method for detection of text data using the candidate words, in accordance with an embodiment of the disclosure;

FIG. 8 is a flowchart of a first method for generation of the candidate words, in accordance with an embodiment of the disclosure;

FIG. 9 is a flowchart of a second method for generation of the candidate words, in accordance with an embodiment of the disclosure; and

FIG. 10 is a flowchart of a third method for generation of the candidate words, in accordance with an embodiment of the disclosure.

### DETAILED DESCRIPTION

According to an embodiment of the disclosure, there is provided a computer-implemented method for generation of candidate words. The computer-implemented method includes obtaining, by a computer, a plurality of character codes associated with a plurality of characters. The plurality of characters is associated with a plurality of words. The computer-implemented method further includes generating, by the computer, a first set of candidate words based on the plurality of character codes. Each candidate word of the first set of candidate words comprises a combination of at least two character codes of the plurality of character codes. Further, each of the at least two character codes is associated with a corresponding word from the plurality of words. The computer-implemented method further includes generating, by the computer, a second set of candidate words based on an application of a set of predefined criteria on the first set of candidate words. The set of predefined criteria is associated with a likelihood of generation of each of the first set of candidate words by an artificial intelligence (AI) model. The computer-implemented method further includes outputting, by the computer, the second set of candidate words for detecting text data generated by the AI model.

In an embodiment of the disclosure, the computer-implemented method further includes receiving, by the computer, the text data. The computer-implemented method further includes identifying, by the computer, an occurrence of at least one of the second set of candidate words in the text data. The computer-implemented method further includes outputting, by the computer, a notification indicating that the text data is generated by the AI model. The outputting is based on the occurrence of the at least one of the second set of candidate words in the text data.

In an embodiment of the disclosure, the computer-implemented method further includes identifying, by the computer, a first word from the plurality of words. The first word comprises a first character and a second character of the plurality of characters. The computer-implemented method further includes identifying, by the computer, a second word from the plurality of words. The second word comprises the first character and a third character of the plurality of characters. The computer-implemented method further includes obtaining, by the computer, a first character code associated with the first character, a second character code associated with the second character and a third character code associated with the third character. Each of the first character code, the second character code and the third character code is one of the plurality of character codes. The computer-implemented method further includes generating, by the computer, a potential candidate word for the first set of candidate words, based on the first character code and a combination of the second character code and the third character code.

In an embodiment of the disclosure, the potential candidate word comprises the first character and a fourth character of the plurality of characters. The fourth character is associated with a combination of a part of each of the second character code and the third character code.

In an embodiment of the disclosure, the computer-implemented method further includes comparing, by the computer, the potential candidate word with each of the plurality of words. The computer-implemented method further includes adding, by the computer, the potential candidate word to the first set of candidate words based on a determination that each of the plurality of words is distinct from the potential candidate word.

In an embodiment of the disclosure, the computer-implemented method further includes applying, by the computer, the set of predefined criteria on a first candidate word from the first set of candidate words. The first candidate word being generated based on a first word and a second word from the plurality of words. The first candidate word comprises a first part and a second part. The first part is associated with a common part of the first word and the second word. The second part is associated with a combination of a different part of each of the first word and the second word. The first candidate word is associated with a set of first character codes of the plurality of character codes. The computer-implemented method further includes adding, by the computer, the first candidate word to the second set of candidate words based on a determination that the first candidate word satisfies at least one predefined criterion of the set of predefined criteria.

In an embodiment of the disclosure, the set of predefined criteria comprises at least one of a first criterion associated with a determination that the common part corresponds to a starting part of each of the first word and the second word, a second criterion associated with a determination that a usage of the second part of the first candidate word for a predefined time period is less than a threshold, and a third criterion associated with a determination that a similarity score between the first word and the second word is greater than a similarity threshold.

In an embodiment of the disclosure, the set of predefined criteria is associated with tokenization of each of the plurality of characters. The set of predefined criteria further comprises at least one of a fourth criterion associated with a determination that a number of tokens associated with each of the first candidate word, the first word, and the second word is equivalent, a fifth criterion associated with a determination that a token id associated with the second part of the first candidate word is within a predefined range, and a sixth criterion associated with a determination that a difference between a token id of the different part of each of the first word and the second word is less than a difference threshold.

In an embodiment of the disclosure, the AI model is a large language model (LLM).

In an embodiment of the disclosure, each of the plurality of words is associated with a language. The language is at least one of Korean, Chinese, or Japanese.

According to another embodiment of the disclosure, there is provided a system for generation of candidate words. The system includes a processor set configured to receive text data. The processor set is further configured to obtain a plurality of character codes associated with a plurality of characters. The plurality of characters is associated with a plurality of words. The processor set is further configured to generate a first set of candidate words based on the plurality of character codes. Each candidate word of the first set of candidate words comprises a combination of at least two character codes of the plurality of character codes. Further, each of the at least two character codes is associated with a corresponding word from the plurality of words. The processor set is further configured to generate a second set of candidate words based on an application of a set of predefined criteria on the first set of candidate words. The set of predefined criteria is associated with a likelihood of generation of each of the first set of candidate words by an artificial intelligence (AI) model. The processor set is further configured to identify an occurrence of at least one of the second set of candidate words in the text data. The processor set is further configured to output a notification to indicate that the text data is generated by the AI model. The outputting is based on the occurrence of the at least one of the second set of candidate words in the text data.

In an embodiment of the disclosure, the processor set is further configured to identify a first word from the plurality of words. The first word comprises a first character and a second character of the plurality of characters. The processor set is further configured to identify a second word from the plurality of words. The second word comprises the first character and a third character of the plurality of characters. The processor set is further configured to obtain a first character code associated with the first character, a second character code associated with the second character and a third character code associated with the third character. Each of the first character code, the second character code and the third character code is one of the plurality of character codes. The processor set is further configured to generate a potential candidate word for the first set of candidate words, based on the first character code and a combination of the second character code and the third character code.

In an embodiment of the disclosure, the potential candidate word comprises the first character and a fourth character of the plurality of characters. The fourth character is associated with a combination of a part of each of the second character code and the third character code.

In an embodiment of the disclosure, the processor set is further configured to compare the potential candidate word with each of the plurality of words. The processor set is further configured to add the potential candidate word to the first set of candidate words based on determination of each of the plurality of words being distinct from the potential candidate word.

In an embodiment of the disclosure, the processor set is further configured to apply the set of predefined criteria on a first candidate word from the first set of candidate words. The first candidate word being generated based on a first word and a second word from the plurality of words. The first candidate word comprises a first part and a second part. The first part is associated with a common part of the first word and the second word. The second part is associated with a combination of a different part of each of the first word and the second word. The first candidate word is associated with a set of first character codes of the plurality of character codes. The processor set is further configured to add the first candidate word to the second set of candidate words based on a determination that the first candidate word satisfies at least one predefined criterion of the set of predefined criteria.

In an embodiment of the disclosure, the set of predefined criteria comprises at least one of a first criterion associated with a determination that the common part corresponds to a starting part of each of the first word and the second word, a second criterion associated with a determination that a usage of the second part of the first candidate word for a predefined time period is less than a threshold, and a third criterion associated with a determination that a similarity score between the first word and the second word is greater than a similarity threshold.

In an embodiment of the disclosure, the set of predefined criteria is associated with tokenization of each of the plurality of characters. The set of predefined criteria further comprises at least one of a fourth criterion associated with a determination that a number of tokens associated with each of the first candidate word, the first word, and the second word is equivalent, a fifth criterion associated with a determination that a token id associated with the second part of the first candidate word is within a predefined range, and a sixth criterion associated with a determination that a difference between a token id of the different part of each of the first word and the second word is less than a difference threshold.

According to yet another embodiment of the disclosure, there is provided a computer program product for generation of candidate words. The computer program product includes a computer-readable storage medium having program instructions embodied therewith, the program instructions executable by a system to cause the processor set included in the system to obtain a plurality of character codes associated with a plurality of characters. The plurality of characters is associated with a plurality of words. The processor set is further configured to generate a first set of candidate words based on the plurality of character codes. Each candidate word of the first set of candidate words comprises a combination of at least two character codes of the plurality of character codes. Further, each of the at least two character codes is associated with a corresponding word from the plurality of words. The processor set is further configured to generate a second set of candidate words based on an application of a predefined criterion on each of the first set of candidate words. The predefined criterion is associated with determination of a similarity score to be greater than a similarity threshold. The similarity score is determined for each of at least a pair of words from the plurality of words associated with each of the first set of candidate words. The processor set is further configured to output the second set of candidate words for detecting text data generated by an artificial intelligence (AI) model.

In an embodiment of the disclosure, the processor set is further configured to receive the text data. The processor set is further configured to identify an occurrence of at least one of the second set of candidate words in the text data. The processor set is further configured to output a notification to indicate that the text data is generated by the AI model. The outputting is based on the occurrence of the at least one of the second set of candidate words in the text data.

In an embodiment of the disclosure, the processor set is further configured to identify a first word from the plurality of words. The first word comprises a first character and a second character of the plurality of characters. The processor set is further configured to identify a second word from the plurality of words. The second word comprises the first character and a third character of the plurality of characters. The processor set is further configured to obtain a first character code associated with the first character, a second character code associated with the second character and a third character code associated with the third character. Each of the first character code, the second character code and the third character code is one of the plurality of character codes. The processor set is further configured to generate a potential candidate word for the first set of candidate words, based on the first character code and a combination of the second character code and the third character code. The processor set is further configured to compare the potential candidate word with each of the plurality of words. The processor set is further configured to add the potential candidate word to the first set of candidate words based on a determination that each of the plurality of words is distinct from the potential candidate word.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

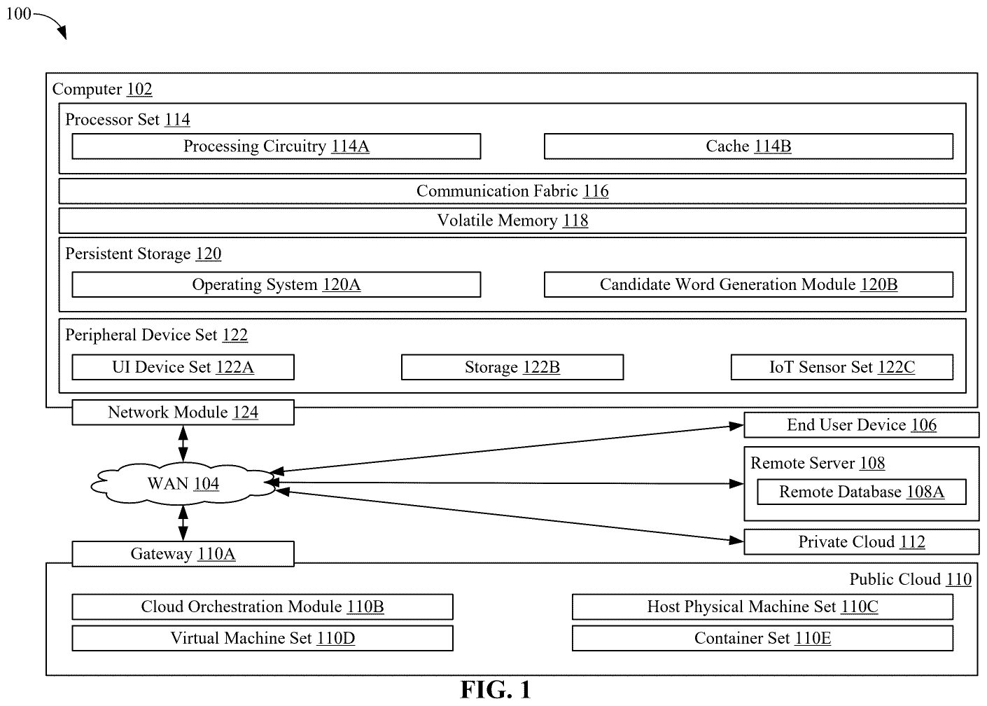

FIG. 1 is a diagram that illustrates a computing environment 100, in accordance with an embodiment of the disclosure. The diagram contains an exemplary environment for execution of at least one module involved in performing the methods, such as a candidate word generation module 120B associated with the generation of the candidate words. In addition to the candidate word generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the candidate word generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the candidate word generation module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The candidate word generation module 120B typically includes the at least one module involved in performing the methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economics of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

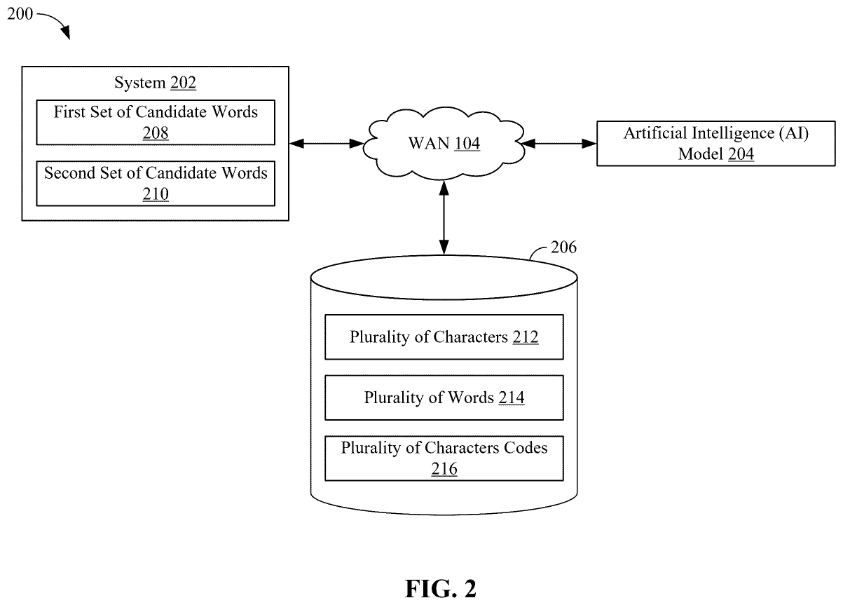

FIG. 2 is a diagram that illustrates a network environment 200 in which a system 202 for generation of the candidate words is implemented, in accordance with an embodiment of the disclosure. FIG. 2 is explained in conjunction with elements from FIG. 1. The network environment 200 includes the system 202, an artificial intelligence (AI) model 204, and a database 206. The system 202 further includes a first set of candidate words 208 and a second set of candidate words 210. The database 206 further includes a plurality of characters 212, a plurality of words 214, and a plurality of character codes 216. The network environment 200 further includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured to generate the candidate words for detection of text data generated by the AI model 204. In an embodiment of the disclosure, the text data generated by the AI model 204 may be referred to as “AI text data”. In an embodiment of the disclosure, the end user associated with the EUD 106 may utilize the AI text data for various purposes (such as generation of articles, research papers or reports). In another embodiment of the disclosure, due to an ability of the AI model 204 to generate the AI text data in a large volume, one or more machine learning (ML) models may be trained based on the AI text data.

However, the AI text data may include persuasive but false text data. In an embodiment of the disclosure, the false text data may include a false text that is inaccurate corresponding to the actual events occurred over the first period of time. In an example embodiment of the disclosure, the false text may correspond to at least one of a false historical text associated with historical events, a false scientific text associated with scientific discoveries, and a false regulation text associated with laws and regulations. In another embodiment of the disclosure, the false text data may include an outdated text that is updated over the first period of time. In an example embodiment of the disclosure, the outdated text may correspond to at least one of an outdated scientific text associated with the scientific discoveries, and an outdated health recommendation associated with health information. In an embodiment of the disclosure, the system 202 may be configured to detect the AI text data to prevent a distribution of the false text data or the outdated text data to the end user associated with the EUD 106.

In another embodiment of the disclosure, the training of the one or more ML models on the AI text data may lead to a decrease in an accuracy of an output of the one or more ML models. In an example embodiment of the disclosure, the one or more ML models may generate inaccurate recommendations based on the false text or the outdated text. In another embodiment of the disclosure, the system 202 may be configured to detect the AI text data to effectively train the one or more ML models.

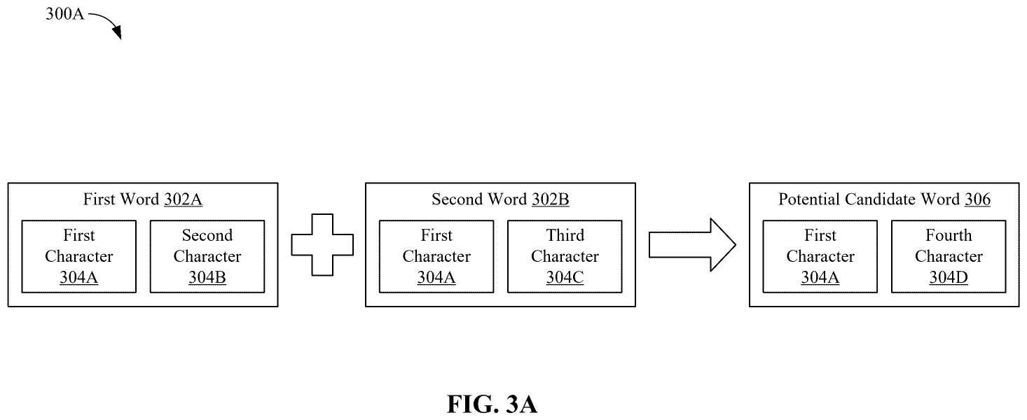

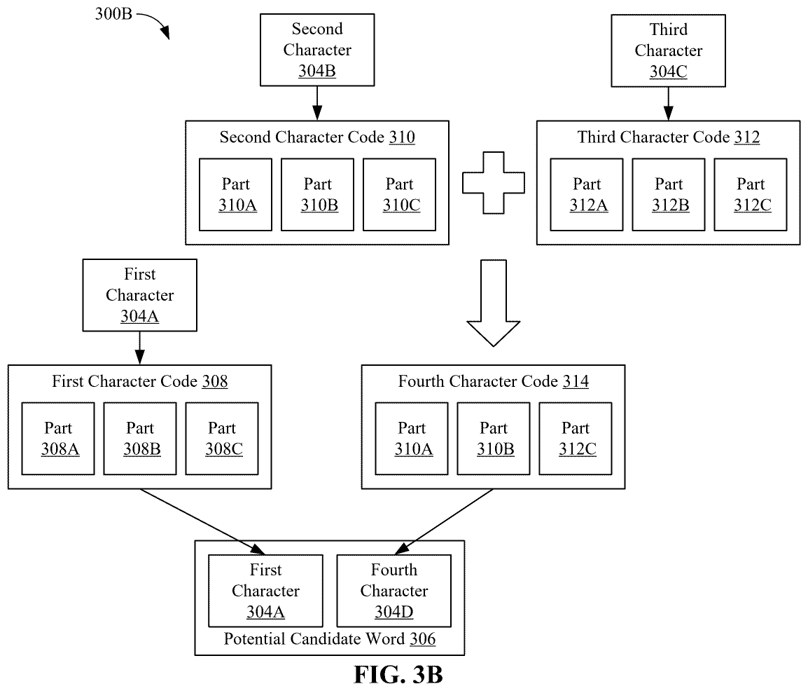

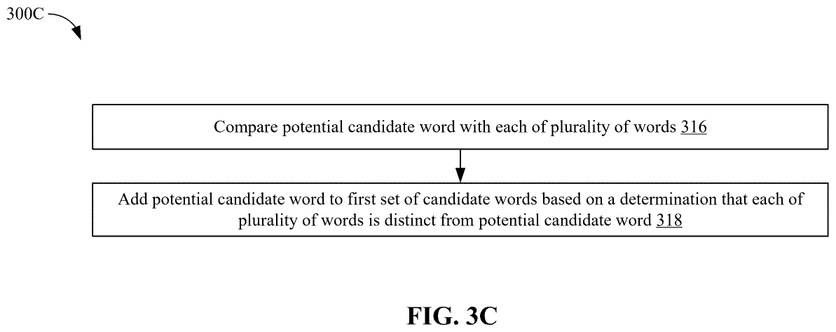

In an embodiment of the disclosure, the system 202 may be configured to detect the AI text data based on the candidate words. The candidate words may correspond new words that the AI model 204 may generate based on a combination of the plurality of characters 212. In an embodiment of the disclosure, to generate the AI text data, the AI model 204 may predict a next word based on a sequence of previous words. In an embodiment of the disclosure, each previous word of the sequence of previous words may be associated with the plurality of words 214. In an embodiment of the disclosure, the predicted next word may correspond to a candidate word based on a determination that an interpretation is absent for the predicted next word. Details about the generation of the candidate words based on the plurality of characters 212 are provided, for example, in FIG. 3A and FIG. 3B. Additionally or alternatively, a limited volume of training data for the training of AI model 204 may increase a likelihood of the generation of the candidate words by the AI model 204. In another embodiment of the disclosure, the AI model 204 may generate the candidate words based on an absence of a word in the training data to indicate one or more contexts associated with the actual events occurred over the first period of time. In yet another embodiment of disclosure, the training data may include jargons, technical terms, slangs, grammatical errors, and non-standard language that may further increase the likelihood of the generation of the candidate words by the AI model 204.

In an embodiment of the disclosure, the AI model 204 may generate the candidate words based on the plurality of character codes 216 associated with the plurality of characters 212. Specifically, the AI model 204 may generate the candidate words based on a combination of one or more parts of the plurality of characters codes 216. In an embodiment of the disclosure, to detect the AI text data, the system 202 may be configured to generate the candidate words based on the plurality of characters 212, the plurality of words 214, and the plurality of character codes 216.

In operation, the system 202 may be configured to obtain the plurality of character codes 216 associated with the plurality of characters 212. Further, the plurality of characters 212 is associated with the plurality of words 214. In an embodiment of the disclosure, the plurality of words 214 may correspond to actual words having at least one interpretation. In an embodiment of the disclosure, the system 202 may be configured to obtain at least one of the plurality of characters 212, the plurality of words 214, and the plurality of characters codes 216 from the database 206.

In an embodiment of the disclosure, the plurality of characters 212 may be associated with a language. The language may include at least one of Japanese, Korean, and Chinese. In an example embodiment of the disclosure, the plurality of characters 212 associated with the Japanese language includes, for example, [symbol] , [symbol] , [symbol] , [symbol] , [symbol] , and [symbol] . In an embodiment of the disclosure, the plurality of words 214 may be associated with the language. In an example embodiment of the disclosure, the plurality of words 214 associated with the Japanese language includes, for example, [symbol] , [symbol] , [symbol] , and [symbol] .

In an embodiment of the disclosure, the system 202 may be configured to obtain the plurality of character codes 216 based on an encoding of the plurality of characters 212. The encoding may include, but is not limited to, a universal transformation format (UTF)-8 encoding, a UTF-16 encoding, and the like. The UTF-8 encoding is a variable-length encoding that indicates each of the plurality of characters 212 with a variable number of bytes (such as 1 byte, 2 bytes, 3 bytes and 4 bytes). The UTF-8 encoding is further backward-compatible with American Standard Code for Information Interchange (ASCII) encoding, thereby the plurality of characters 212 are indicated with common encoding in the ASCII encoding and the UTF-8 encoding. Further, in the UTF-8 encoding, other non-ASCII characters associated with the plurality of characters 212 are indicated by the 2 bytes 3 bytes, and 4 bytes. By way of an example and not limitation, the plurality of character codes 216 includes, for example, e8 a6 96, c8 a6 9a, and e8 81 b4.

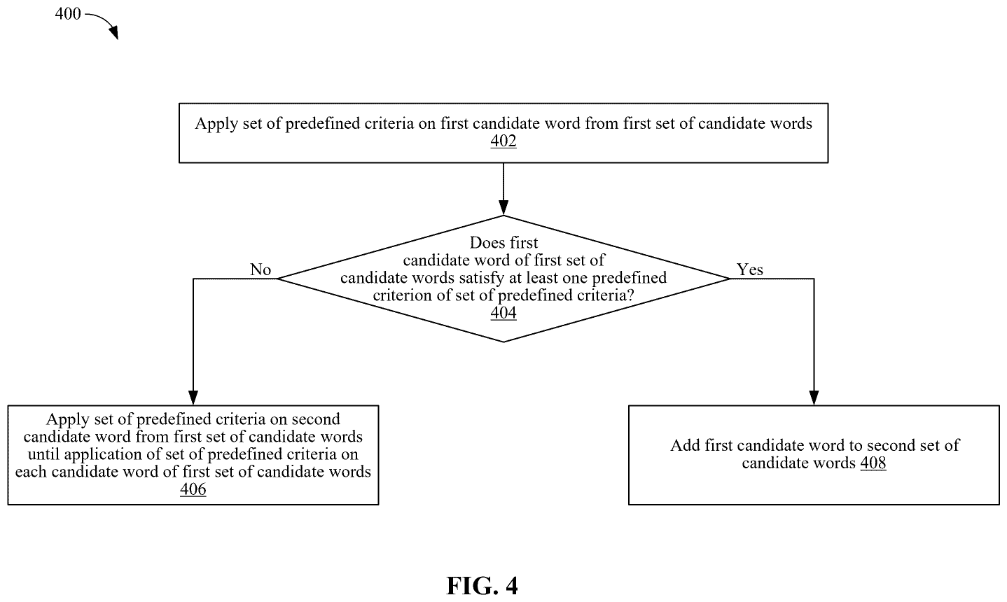

In an embodiment of the disclosure, the system 202 may be configured to generate the first set of candidate words 208 based on the plurality of character codes 216. Each candidate word of the first set of candidate words 208 may include a combination of at least two character codes of the plurality of character codes 216. Further, each of the at least two character codes is associated with a corresponding word from the plurality of words 214. Details about the generation of the first set of candidate words 208 based on the plurality of character codes 216 are provided, for example, in FIG. 3A, FIG. 3B, FIG. 3C, and FIG. 4.

In an embodiment of the disclosure, the system 202 may be configured to generate the second set of candidate words 210 based on an application of a set of predefined criteria on each of the first set of candidate words 208. The set of predefined criteria is associated with a likelihood of generation of each of first set of candidate words 208 by the AI model 204. In an embodiment of the disclosure, the system 202 may be configured to determine a number of candidate words in the first set of candidate words 208. The system 202 may be further configured to generate the second set of candidate words 210 based on a determination that the number of candidate words in the first set of candidate words 208 is greater than a predefined number. In an embodiment of the disclosure, the system 202 may be configured to apply the set of predefined criteria on the first set of candidate words 208 to decrease the number of candidate words in the first set of candidate words 208. The decrease in the number of candidate words allows for a decrease in a computational complexity associated with the detection of the AI text data based on the first set of candidate words 208. Additionally or alternatively, a likelihood of the generation of each of the second set of candidate words 210 by the AI model 204 is greater than the likelihood of the generation of each of the first set of candidate words 208 by the AI model 204.

In an embodiment of the disclosure, the system 202 may be configured to output the second set of candidate words 210 for detecting the AI text data. In an embodiment of the disclosure, the system 202 may be configured to output the second set of candidate words 210 on a user interface associated with the system 202. In another embodiment of the disclosure, the system 202 may be configured to render an audio output indicative of the second set of candidate words 210. In an embodiment of the disclosure, the system 202 may be configured to store at least one of the first set of candidate words 208 or the second set of candidate words 210 in the database 206. Further, to detect the AI text data, the system 202 may be configured to obtain at least one of the first set of candidate words 208 or the second set of candidate words 210 from the database 206.

The AI model 204 may be a computational network or a system of artificial neurons, arranged in a plurality of layers, as nodes. The plurality of layers of the AI model 204 may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the AI model 204. Outputs of each hidden layer may be coupled to inputs of at least one node in other layers of the AI model 204. Node(s) in the final layer may receive inputs from at least one hidden layer to output a result (such as the AI text data). The number of layers and the number of nodes in each layer may be determined from hyper-parameters of the AI model 204. Such hyper-parameters may be set before or while the training the AI model 204 on a training dataset.

Each node of the AI model 204 may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the AI model 204. All or some of the nodes of the AI model 204 may correspond to the same or a different mathematical function.

In the training of the AI model 204, one or more parameters of each node of the AI model 204 may be updated based on whether an output of the final layer for a given input (from the training dataset) matches a correct result based on a loss function for the AI model 204. The above process may be repeated for the same or a different input until a minima of loss function may be achieved, and a training error may be minimized. Several methods for training are known in art, for example, gradient descent, stochastic gradient descent, batch gradient descent, gradient boost, meta-heuristics, and the like.

The AI model 204 may include electronic data, such as, for example, a software program, code of the software program, libraries, applications, scripts, or other logic or instructions for execution by a processing device, such as processor set. The AI model 204 may include code and routines configured to enable a computing device, such as the system 202 to perform one or more operations. Additionally, or alternatively, the AI model 204 may be implemented using hardware including a processor, a microprocessor (e.g., to perform or control performance of one or more operations), a field-programmable gate array (FPGA), or an application-specific integrated circuit (ASIC). Alternatively, in some embodiments, the AI model 204 may be implemented using a combination of hardware and software. Although in FIG. 2, the AI model 204 is shown as a separate entity from the system 202, the disclosure is not so limited. Accordingly, in some embodiments, the AI model 204 may be integrated within the system 202, without deviation from scope of the disclosure. Examples of the AI model 204 may include, but are not limited to, a deep neural network (DNN), a convolutional neural network (CNN), a CNN-recurrent neural network (CNN-RNN), an artificial neural network (ANN), a fully connected neural network, and/or a combination of such networks.

In another embodiment, the AI model 204 may correspond to a computer-based system or software that exhibits characteristics commonly associated with human intelligence. The AI model 204 may be designed to perform tasks that typically require human intelligence, such as problem-solving, learning, reasoning, perception, understanding natural language, and decision-making. AI systems can range from simple rule-based programs to sophisticated, self-learning systems. The AI model 204 may be a sophisticated piece of software that leverages natural language processing (NLP) and machine learning techniques to understand, generate, and manipulate human language. For example, the AI model 204 may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. In an example, the LLM model for language processing may be implemented using GPT, Bidirectional Encoder Representations from Transformers (BERT), and the like.

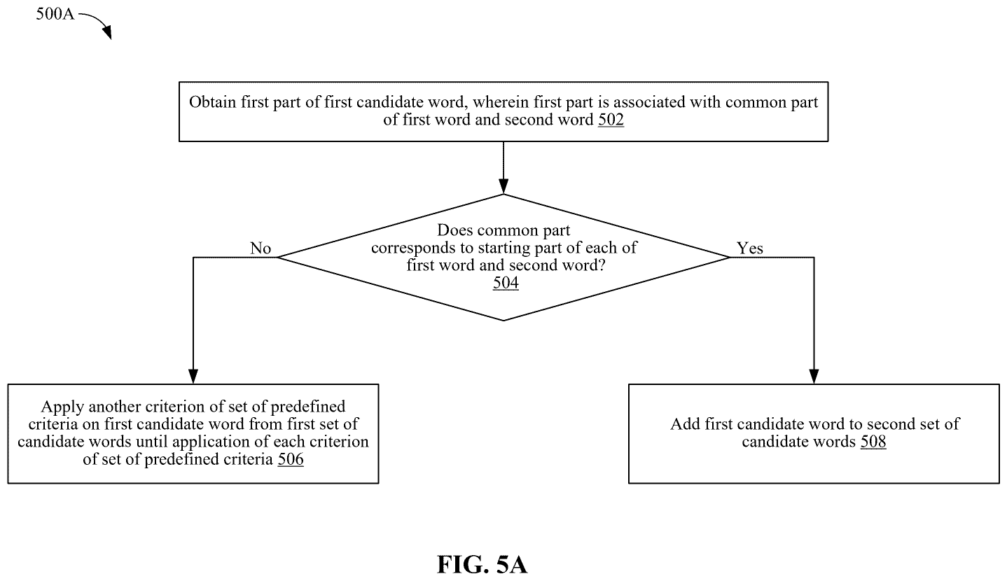

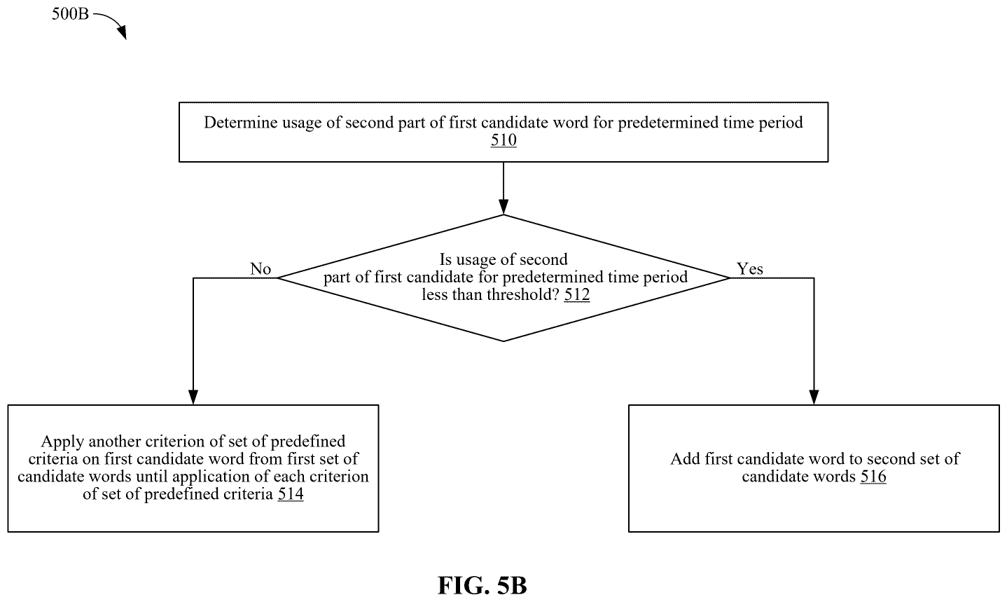

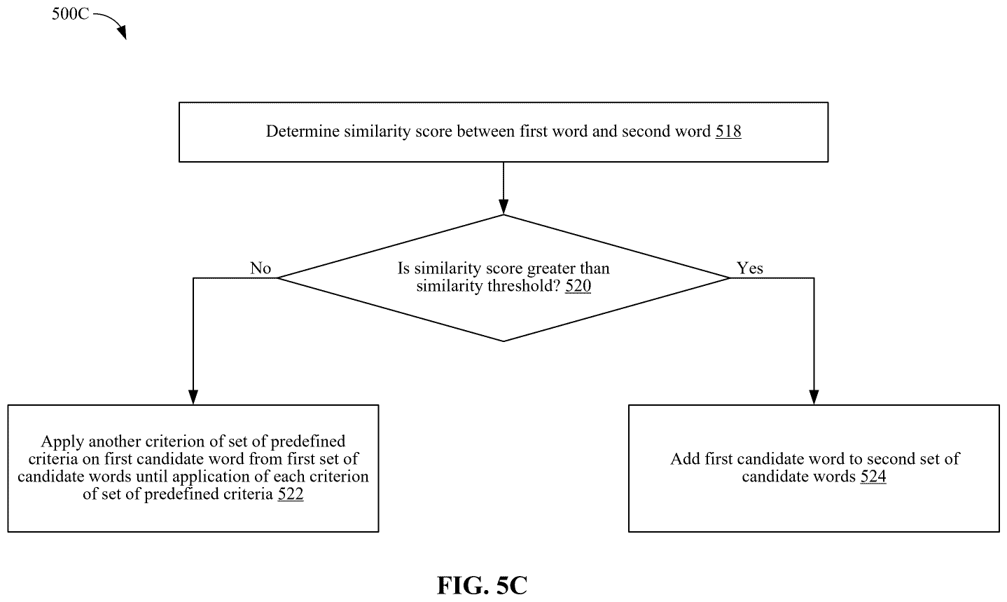

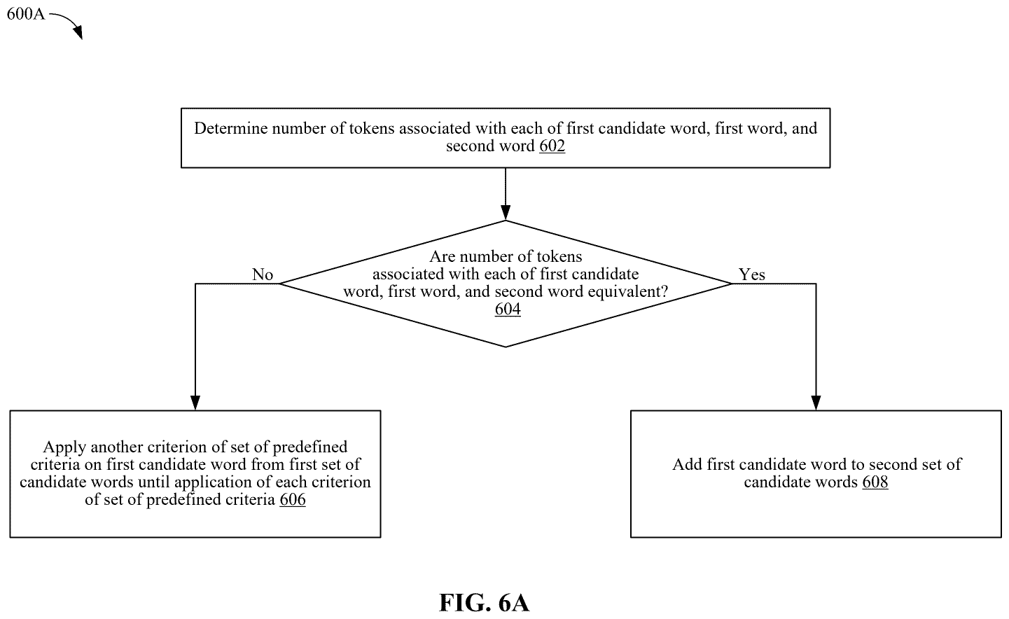

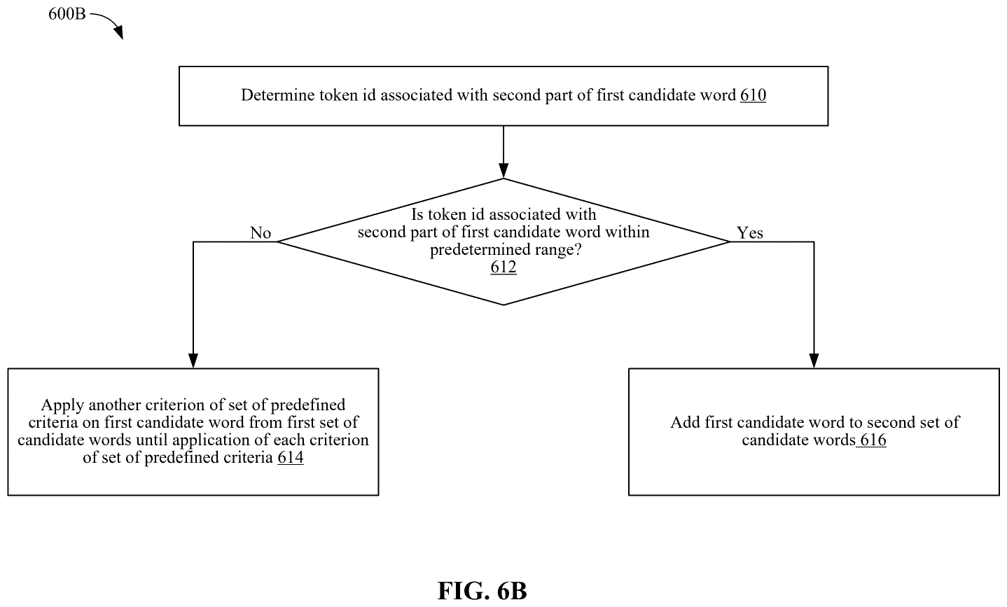

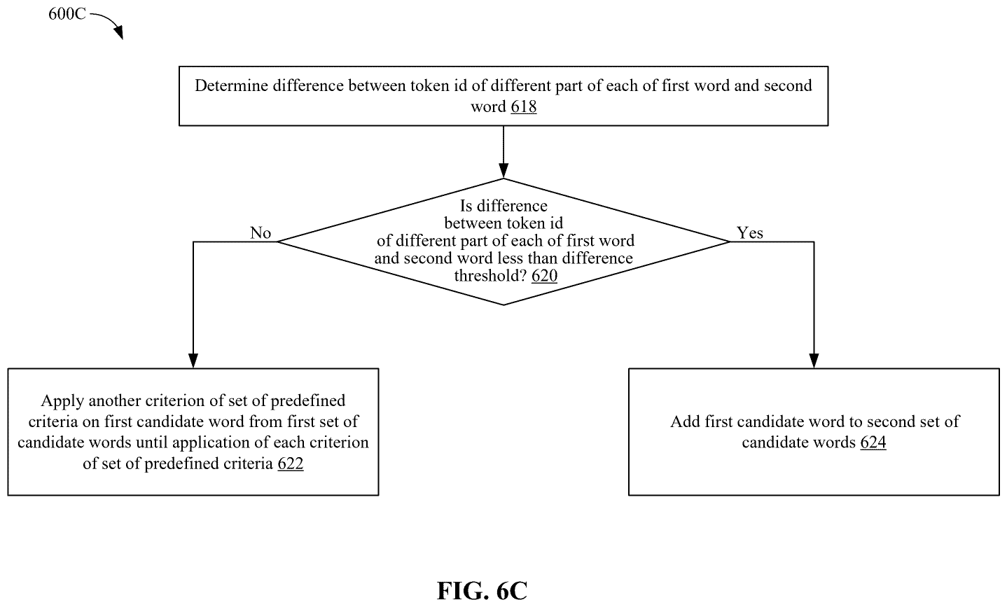

FIG. 3A is a diagram 300A that illustrates exemplary generation of a potential candidate word 306 based on the plurality of words 214, in accordance with an embodiment of the disclosure. FIG. 3A is described in conjunction with FIG. 1 and FIG. 2. The diagram 300A includes a first word 302A, a second word 302B, and the potential candidate word 306. The first word 302A includes a first character 304A and a second character 304B. The second word 302B includes the first character 304A and a third character 304C. The potential candidate word 306 includes the first character 304A and a fourth character 304D. The plurality of words 214 includes the first word 302A, the second word 302B, and the potential candidate word 306. Further, each of the first character 304A, the second character 304B, the third character 304C, and the fourth character 304D is one of the plurality of characters 212. In an embodiment of the disclosure, a likelihood of the generation of the potential candidate word 306 by the AI model 204 may be associated with the set of predefined criteria. In an example embodiment of the disclosure, a contextual similarity between the first word 302A and the second word 302B may lead to the generation of the potential candidate word 306 by the AI model 204. Details about the set of predefined criteria are provided, for example, in FIG. 4, FIG. 5A, FIG. 5B, FIG. 5C, FIG. 6A, FIG. 6B, and FIG. 6C.

In an embodiment of the disclosure, to detect the AI text data, the system 202 may be configured to generate the potential candidate word 306 based on the plurality of words 214. In an embodiment of the disclosure, the system 202 may be configured to identify the first word 302A from the plurality of words 214. In an embodiment of the disclosure, the system 202 may be configured to identify the second word 302B from the plurality of words 214. Specifically, the system 202 may be configured to identify the first word 302A and the second word 302B from the plurality of words 214 based on a determination that the first word 302A and the second word 302B include a common part (such as the first character 304A), respectively.

In an embodiment of the disclosure, the system 202 may be configured to generate the potential candidate word 306 based on the first word 302A and the second word 302B. Specifically, the system 202 may be configured to generate the potential candidate word 306 based on the common part (such as the first character 304A) of the first word 302A and the second word 302B and the fourth character 304D. In an embodiment of the disclosure, the system 202 may be configured to generate the fourth character 304D based on a combination of the second character 304B and the third character 304C. In an embodiment of the disclosure, the system 202 may be configured to determine the potential candidate word 306 based on the plurality of character codes 216. Accordingly a diagram is explained in FIG. 3B.

By way of example and not limitation, the first character 304A, the second character 304B, the third character 304C, and the fourth character 304D correspond to [symbol] , [symbol] , [symbol] , and [symbol] , respectively. Further, the first word 302A, the second word 302B, and the potential candidate word 306 corresponds to [symbol] , [symbol] , and [symbol] , respectively.

FIG. 3B is a diagram 300B that illustrates exemplary generation of the potential candidate word 306 based on the plurality of character codes 216, in accordance with an embodiment of the disclosure. FIG. 3B is described in conjunction with FIG. 1, FIG. 2 and FIG. 3A. The diagram 300B includes a first character code 308, a second character code 310, a third character code 312, and a fourth character code 314. The first character code 308, the second character code 310, the third character code 312, and the fourth character code 314 are associated with the plurality of character codes 216. Further, the first character code 308 includes a part 308A, a part 308B, and a part 308C. The second character code 310 includes a part 310A, a part 310B, and a part 310C. The third character code 312 includes a part 312A, a part 312B, and a part 312C. The fourth character code 314 includes the part 310A, the part 310B, and the part 312C. The diagram 300B further includes the first character 304A, the second character 304B, the third character 304C, and the potential candidate word 306 of FIG. 3A. In an embodiment of the disclosure, the AI model 204 may generate the fourth character code 314 based on the combination of the second character code 310 and the third character code 312. Further, the AI model 204 may generate the potential candidate word 306 based on a combination of the first character code 308 and the fourth character code 314.

In an embodiment of the disclosure, to detect the AI text data, the system 202 may be configured to generate the potential candidate word 306 based on the plurality of character codes 216. In an embodiment of the disclosure, based on the plurality of character codes 216, the system 202 may be configured to obtain the first character code 308 associated with the first character 304A, the second character code 310 associated with the second character 304B, the third character code 312 associated with the third character 304C. Further, in an embodiment of the disclosure, the system 202 may be configured to obtain the fourth character code 314 based on a combination of the part 310A and the part 310B of the second character code 310 and the part 312C of the third character code 312. In an embodiment of the disclosure, the system 202 may be configured to obtain the first character code 308, the second character code 310, the third character code 312, and the fourth character code 314 from the database 206.

By way of an example and not limitation, the first character code 308 for the [symbol] corresponds to e8 a6 96, the second character code 310 for the [symbol] corresponds to e8 a6 9a, the third character code 304C for the [symbol] corresponds to c8 81 b4, and the fourth character code 314 for the [symbol] corresponds to e8 a6 b4. Further, the part 308A, the part 308B, and the part 308C correspond to e8, a6, and 96, respectively. The part 310A, the part 310B, the part 310C correspond to c8, a6, and 9a, respectively. The part 312A, the part 312B, and the part 312C correspond to c8, 81, and b4, respectively.

In an embodiment of the disclosure, the system 202 may be configured to generate the first set of candidate words 208 based on the potential candidate word 306. Accordingly, a flowchart is provided with reference to FIG. 3C.

FIG. 3C is a flowchart 300C of a method for generation of the first set of candidate words 208, in accordance with an embodiment of the disclosure. FIG. 3C is explained in conjunction with elements from FIG. 1, FIG. 2, FIG. 3A, and FIG. 3B. The operations of the method depicted by the flowchart 300C may be executed by any computing system, for example, by the computer 102 of FIG. 1 or the system 202 of FIG. 2. The operations of the flowchart 300C may start at 316.

At 316, the potential candidate word 306 is compared with each of the plurality of words 214. In an embodiment of the disclosure, the system 202 may be configured to compare the potential candidate word 306 with each of the plurality of words 214.

At 318, the potential candidate word 306 is added to the first set of candidate words 208 based on a determination that each of the plurality of words 214 is distinct from the potential candidate word 306. In an embodiment of the disclosure, the system 202 may be configured to add the potential candidate word 306 to the first set of candidate words 208. In an embodiment of the disclosure, the potential candidate word 306 added to the first set of candidate words 208 may correspond to a first candidate word of the first set of candidate words 208.

In an embodiment of the disclosure, the system 202 may be configured to generate the second set of candidate words 210 based on the application of the set of predefined criteria on the first candidate word from the first set of candidate words 208. Accordingly, a flowchart is provided with reference to FIG. 4.

FIG. 4 is a flowchart 400 of a method for generation of the second set of candidate words 210, in accordance with an embodiment of the disclosure. FIG. 4 is explained in conjunction with elements from FIG. 1, FIG. 2, FIG. 3A, FIG. 3B, and FIG. 3C. The operations of the method depicted by the flowchart 400 may be executed by any computing system, for example, by the computer 102 of FIG. 1 or the system 202 of FIG. 2. The operations of the flowchart 400 may start at 402.

At 402, the set of predefined criteria is applied on the first candidate word from the first set of candidate words 208. In an embodiment of the disclosure, the system 202 may be configured to apply the set of criteria on the first candidate word from the first set of candidate words 208. The first candidate word being generated based on the first word 302A and the second word 302B from the plurality of words 214. The first candidate word includes a first part and a second part. The first part is associated with the common part (such as the first character 304A) of the first word 302A and the second word 302B. The second part is associated with the combination of the different part of each of the first word 302A and the second word 302B. In an example embodiment of the disclosure, the different part of the first word 302A and the second word 302B corresponds to the second character 304B and the third character 304C, respectively. In an embodiment of the disclosure, the first candidate word is associated with a set of first character codes of the plurality of character codes 216. In an example embodiment of the disclosure, the set of first character codes includes the first character code 308, and the fourth character code 314.

At 404, a determination is made whether the first candidate word satisfies at least one predefined criterion of the set of predefined criteria or not. In an embodiment of the disclosure, the system 202 may be configured to determine whether the first candidate word satisfies the at least one predefined criterion of the set of predefined criteria or not. If the first candidate word does not satisfy the at least one predefined criterion of the set of predefined criteria, then at 406, the system 202 may be configured to apply the set of predefined criteria on a second candidate word from the first set of candidate words 208 until the application of the set of predefined criteria on each candidate word of the first set of candidate words 208. Otherwise, the operations of the flowchart 400 may continue at 408 to generate the second set of candidate words 210.

At 408, the first candidate word is added to the second set of candidate words 210 based on a determination that the first candidate word satisfies the at least one predefined criterion of the set of predefined criteria. In an embodiment of the disclosure, based on the determination that the first candidate word satisfies the at least one predefined criterion of the set of predefined criteria, the system 202 may be configured to add the first candidate word to the second set of candidate words 210. Referring back at 406, the system 202 may be further configured to apply the set of predefined criteria on the second candidate word from the first set of candidate words 208 until the application of the set of predefined criteria on each candidate word of the first set of candidate words 208.

In an embodiment of the disclosure, the system 202 may be configured to add the first candidate word to the second set of candidate words 210 based on an application of a first criterion of the set of predefined criteria on the first candidate word. Accordingly a flowchart is described with reference to FIG. 5A.

FIG. 5A is a flowchart 500A of a method for application of the first criterion on the first set of candidate words 208, in accordance with an embodiment of the disclosure. FIG. 5A is explained in conjunction with elements from FIG. 1, FIG. 2, FIG. 3A, FIG. 3B, and FIG. 4. The operations of the method depicted by the flowchart 500A may be executed by any computing system, for example, by the computer 102 of FIG. 1 or the system 202 of FIG. 2. The operations of the flowchart 500A may start at 502.

At 502, the first part of the first candidate word is obtained. The first part is associated with the common part (such as the first character 304A) of the first word 302A and the second word 302B. In an embodiment of the disclosure, the common part of the first word 302A and the second word 302B may be associated with the likelihood of the generation of the first candidate word by the AI model 204. In an embodiment of the disclosure, the likelihood of the generation of the first candidate word by the AI model 204 may increase corresponding to a presence of the common part in the first word 302A and the second word 302B. In an example embodiment of the disclosure, the AI model 204 may generate the first candidate word based on common first four bytes of the first word 302A and the second word 302B. In an embodiment of the disclosure, the system 202 may be configured to obtain the first part of the first candidate word from the database 206.

At 504, a determination is made whether the common part corresponds to a starting part of each of the first word 302A and the second word 302B or not. In an embodiment of the disclosure, the system 202 may be configured to determine whether the common part corresponds to the starting part of each of the first word 302A and the second word 302B or not. If the common part does not correspond to the starting part of each of the first word 302A and the second word 302B, then at 506, the system 202 may be configured to apply another criterion of the set of predefined criteria on the first candidate word from the first set of candidate words 208. In an embodiment of the disclosure, the system 202 may be configured to apply another criterion of the set of predefined criteria until the application of each criterion of set of predefined criteria on the first candidate word. Otherwise, the operations of the flowchart 500A may continue at 508 to generate the second set of candidate words 210.

At 508, the first candidate word is added to the second set of candidate words 210 based on a determination that the common part corresponds to the starting part of each of the first word 302A and the second word 302B. In an embodiment of the disclosure, the system 202 may be configured to add the first candidate word to the second set of candidate words 210 based on a determination that the common part corresponds to the starting part of each of the first word 302A and the second word 302B.

In an embodiment of the disclosure, the system 202 may be configured to add the first candidate word to the second set of candidate words 210 based on an application of a second criterion of the set of predefined criteria on the first candidate word. Accordingly a flowchart is described with reference to FIG. 5B.

FIG. 5B is a flowchart 500B of a method for application of the second criterion on the first set of candidate words 208, in accordance with an embodiment of the disclosure. FIG. 5B is explained in conjunction with elements from FIG. 1, FIG. 2, FIG. 3A, FIG. 3B, FIG. 3C, FIG. 4, FIG. 5A. The operations of the method depicted by the flowchart 500B may be executed by any computing system, for example, by the computer 102 of FIG. 1 or the system 202 of FIG. 2. The operations of the flowchart 500B may start at 510.

At 510, a usage of the second part (such as the fourth character 304D) of the first candidate word for a predefined time period (such as months, years or decades) is determined. In an embodiment of the disclosure, the usage of the second part of the first candidate word for the predetermined time period may be associated with the likelihood of the generation of the first candidate word by the AI model 204. In an embodiment of the disclosure, the likelihood of the generation of the first candidate word by the AI model 204 may increase corresponding to a decrease in the usage of the second part of the first candidate word for the predefined time period. In an example embodiment of the disclosure, the AI model 204 may generate the first candidate word based on an infrequently used word associated with the language.

In an embodiment of the disclosure, the system 202 may be configured to determine the usage of the second part of the first candidate word for the predefined time period. In an embodiment of the disclosure, the system 202 may be configured to obtain usage information associated with the second part of the first candidate word. The usage information may be indicative of the usage of the second part of the first candidate word for the predefined time period. In an embodiment of the disclosure, the system 202 may be configured to obtain the usage information from the database 206.

At 512, a determination is made whether the usage of the second part of the first candidate word for the predefined time period is less than a threshold or not. In an embodiment of the disclosure, the system 202 may be configured to determine whether the usage of the second part of the first candidate word for the predefined time period is less than a threshold or not. If the usage of the second part of the first candidate word for the predefined time period is not less than the threshold, then at 514, the system 202 may be configured to apply another criterion of the set of predefined criteria on the first candidate word from the first set of candidate words 208. In an embodiment of the disclosure, the system 202 may be configured to apply another criterion of the set of predefined criteria until the application of each criterion of set of predefined criteria on the first candidate word. Otherwise, the operations of the flowchart 500B may continue at 516 to generate the second set of candidate words 210.

At 516, the first candidate word is added to the second set of candidate words 210 based on a determination that the usage of the second part of the first candidate word for the predefined time period is less than the threshold. In an embodiment of the disclosure, the system 202 may be configured to add the first candidate word to the second set of candidate words 210 based on the determination that the usage of the second part of the first candidate word for the predefined time period is less than the threshold.

In an embodiment of the disclosure, the system 202 may be configured to add the first candidate word to the second set of candidate words 210 based on an application of a third criterion of the set of predefined criteria on the first candidate word. Accordingly, a flowchart is described with reference to FIG. 5C.

FIG. 5C is a flowchart 500C of a method for application of the third criterion on the first candidate word, in accordance with an embodiment of the disclosure. FIG. 5C is explained in conjunction with elements from FIG. 1, FIG. 2, FIG. 3A, FIG. 3B, FIG. 3C, FIG. 4, FIG. 5A, and FIG. 5B. The operations of the method depicted by the flowchart 500C may be executed by any computing system, for example, by the computer 102 of FIG. 1 or the system 202 of FIG. 2. The operations of the flowchart 500C may start at 518.

At 518, a similarity score between the first word 302A and the second word 302B is determined. In the embodiment of the disclosure, the system 202 may be configured to determine the similarity score between the first word 302A and the second word 302B. The similarity score may be indicative of a contextual similarity between the first word 302A and the second word 302B. In an embodiment of the disclosure, the contextual similarity between the first word 302A and the second word 302B may be associated with the likelihood of the generation of the first candidate word by the AI model 204. In an embodiment of the disclosure, the likelihood of the generation of the first candidate word by the AI model 204 may increase corresponding to an increase in the contextual similarity between the first word 302A and the second word 302B. In an embodiment of the disclosure, the system 202 may be configured to determine a first similarity vector for the first word 302A. The system 202 may be further configured to determine a second similarity vector for the second vector for the second word 302B. In an embodiment of the disclosure, the system 202 may employ one or more embedding models to generate the first similarity vector and the second similarity vector for the first word 302A and the second word 302B, respectively. Examples of the one or more embedding models may include, but are not limited to, a word to vector (Word2Vec) model, a global vectors for word representation (GloVe) model, and the like. In an embodiment of the disclosure, the one or more embedding models may be implemented based on a Transformer architecture that effectively captures long-range dependencies and contextual information in the language associated with the plurality of words 214. In an example embodiment of the disclosure, the one or more embedding models may include, but are not limited to, a bidirectional encoder representation from transformers (BERT), a generative pre-trained transformer (GPT), and the like. Moreover, the Transformer architecture may use attention mechanisms to weigh the significance of the first word 302A and the second word 302B in an input sequence associated with the plurality of words 214. In addition, the one or more embedding models may employ bidirectional processing to consider context from both directions when analyzing the input sequence associated with the plurality of words 214. This bidirectional approach enhances an ability of the one or more embedding models to understand the context in which the first word 302A or the second word 302B appear. In an example embodiment of the disclosure, the one or more embedding models may generate the first similarity vector and the second similarly vector based on a surrounding context in the input sequence associated with the plurality of words 214. The first similarity vector may be indicative of a first contextual representation of the first word 302A and the second similarity vector may be indicative of a second contextual representation of the second word 302B. The system 202 may be further configured to determine the similarity score based on a distance between the first similarity vector and the second similarity vector. Additionally or alternatively, the system 202 may be configured to normalize the similarity score corresponding to a predefined range. In an embodiment of the disclosure, the system 202 may be configured to determine a similarity score for each of at least a pair of words (such as the first word 302A and the second word 302B) from the plurality of words 214. The plurality of words 214 may be associated with each of the first set of candidate words 208.

By way of an example and not limitation, the first word 302A corresponds to “vision” and the second word 302B corresponds to “see”. The similarity score for “vision” and “see” is 0.9 that may be indicative of a high contextual similarity between both these words. By way of another example and not limitation, the first word 302A corresponds to “vision” and the second word 302B corresponds to “knowledge”. The similarity score for “vision” and “knowledge” is 0.4 that may be indicative of a low contextual similarity between the words “vision” and “knowledge”.

At 520, a determination is made whether the similarity score is greater than a similarity threshold (such as 0.4, 0.5 or 0.6) or not. In an embodiment of the disclosure, the system 202 may be configured to determine whether the similarity score is greater than the similarity threshold or not. If the similarity score is not greater than the similarity threshold, then at 522, the system 202 may be configured to apply another criterion of the set of predefined criteria on the first candidate word from the first set of candidate words 208. In an embodiment of the disclosure, the system 202 may be configured to apply another criterion of the set of predefined criteria until the application of each criterion of set of predefined criteria on the first candidate word. Otherwise, the operations of the flowchart 500C may continue at 524 to generate the second set of candidate words 210.

At 524, the first candidate word is added to the second set of candidate words 210 based on a determination that the similarity score is greater than the similarity threshold. In an embodiment of the disclosure, the system 202 may be configured to add the first candidate word to the second set of candidate words 210 based on the determination that the similarity score is greater than the similarity threshold.

In an embodiment of the disclosure, the set of predefined criteria is associated with the tokenization of each of the plurality of characters 212. The tokenization may include fragmentation of the sequence of texts to generate a plurality of tokens. The plurality of tokens may include, but is not limited to, a set of words, a set of sub-words, and a set of characters. In an embodiment of the disclosure, the AI model 204 may process the plurality of tokens to generate the AI text data. In an embodiment of the disclosure, the system 202 may be configured to indicate the plurality of tokens based on a set of numbers. By way of example and not limitation, a plurality of tokens for the first word 302A, the second word 302B, and the first candidate word correspond to 25038|244|25038|248, 25038|244|36735|112, and 25038|244|36735|112, respectively. Further, the system 202 may be configured to add the first candidate word to the second set of candidate words 210 based on an application of a fourth criterion of the set of predefined criteria on the first candidate word. Accordingly, a flowchart is described with reference to FIG. 6A.

FIG. 6A is a flowchart 600A of a method for application of the fourth criterion on the first candidate word, in accordance with an embodiment of the disclosure. FIG. 6A is explained in conjunction with elements from FIG. 1, FIG. 2, FIG. 3A, FIG. 3B, FIG. 3C, FIG. 4, FIG. 5A, FIG. 5B, and FIG. 5C. The operations of the method depicted by the flowchart 600A may be executed by any computing system, for example, by the computer 102 of FIG. 1 or the system 202 of FIG. 2. The operations of the flowchart 600A may start at 602.

At 602, a number of tokens associated with each of the first candidate word, the first word 302A, and the second word 302B is determined. In an embodiment of the disclosure, the number of tokens associated with the first candidate word, the first word 302A, and the second word 302B may be associated with the likelihood of the generation of the first candidate word by the AI model 204. In an embodiment of the disclosure, the likelihood of the generation of the first candidate word by the AI model 204 may increase corresponding to an equivalence of the number of tokens associated with the first candidate word, the first word 302A, and the second word 302B. In an embodiment of the disclosure, the system 202 may be configured to determine the number of tokens associated with each of the first candidate word, the first word 302A, and the second word 302B.

At 604, a determination is made whether the number of tokens associated with each of the first candidate word, the first word 302A, and the second word 302B is equivalent or not. In an embodiment of the disclosure, the system 202 may be configured to determine whether the number of tokens associated with each of the first candidate word, the first word 302A, and the second word 302B is equivalent or not. If the number of tokens associated with each of the first candidate word, the first word 302A, and the second word 302B is not equivalent, then at 606, the system 202 may be configured to apply another criterion of the set of predefined criteria on the first candidate word from the first set of candidate words 208. In an embodiment of the disclosure, the system 202 may be configured to apply another criterion of the set of predefined criteria until the application of each criterion of set of predefined criteria on the first candidate word. Otherwise, the operations of the flowchart 600A may continue at 608 to generate the second set of candidate words 210.

At 608, the first candidate word is added to the second set of candidate words 210 based on a determination that the number of tokens associated with each of the first candidate word, the first word 302A, and the second word 302B is equivalent. In an embodiment of the disclosure, the system 202 may be configured to add the first candidate word to the second set of candidate words 210 based on the determination that the number of tokens associated with each of the first candidate word, the first word 302A, and the second word 302B is equivalent.

In an embodiment of the disclosure, the system 202 may be configured to add the first candidate word to the second set of candidate words 210 based on an application of a fifth criterion of the set of predefined criteria on the first candidate word. Accordingly a flowchart is described with reference to FIG. 6B.

FIG. 6B is a flowchart 600B of a method for application of the fifth criterion on the first candidate word, in accordance with an embodiment of the disclosure. FIG. 6B is explained in conjunction with elements from FIG. 1, FIG. 2, FIG. 3A, FIG. 3B, FIG. 3C, FIG. 4, FIG. 5A, FIG. 5B, FIG. 5C, and FIG. 6A. The operations of the method depicted by the flowchart 600B may be executed by any computing system, for example, by the computer 102 of FIG. 1 or the system 202 of FIG. 2. The operations of the flowchart 600B may start at 610.

At 610, a token identifier (id) associated with the second part (such as the fourth character 304D) of the first candidate word is determined. In an embodiment of the disclosure, the token id associated with the second part of the first candidate word may be associated with the likelihood of the generation of the first candidate word by the AI model 204. In an embodiment of the disclosure, the likelihood of the generation of the first candidate word by the AI model 204 may increase corresponding to the token id that is within a predefined range. In an embodiment of the disclosure, the system 202 may be configured to determine the token id associated with the second part of the first candidate word.

At 612, a determination is made whether the token id associated with the second part of the first candidate word is within the predefined range or not. In an embodiment of the disclosure, the system 202 may be configured to determine whether the token id associated with the second part of the first candidate word is within the predefined range or not. If the token id associated with the second part of the first candidate word is not within the predefined range, then at 614, the system 202 may be configured to apply another criterion of the set of predefined criteria on the first candidate word from the first set of candidate words 208. In an embodiment of the disclosure, the system 202 may be configured to apply another criterion of the set of predefined criteria until the application of each criterion of set of predefined criteria on the first candidate word. Otherwise, the operations of the flowchart 600B may continue at 616 to generate the second set of candidate words 210.

At 616, the first candidate word is added to the second set of candidate words 210 based on a determination that the token id associated with the second part of the first candidate word is within the predefined range. In an embodiment of the disclosure, the system 202 may be configured to add the first candidate word to the second set of candidate words 210 based on a determination that the token id associated with the second part of the first candidate word is within the predefined range.

In an embodiment of the disclosure, the system 202 may be configured to add the first candidate word to the second set of candidate words 210 based on an application of a sixth criterion of the set of predefined criteria on the first candidate word. Accordingly a flowchart is described with reference to FIG. 6C.

FIG. 6C is a flowchart 600C of a method for application of the sixth criterion on the first candidate word, in accordance with an embodiment of the disclosure. FIG. 6B is explained in conjunction with elements from FIG. 1, FIG. 2, FIG. 3A, FIG. 3B, FIG. 3C, FIG. 4, FIG. 5A, FIG. 5B, FIG. 5C, FIG. 6A, and FIG. 6B. The operations of the method depicted by the flowchart 600C may be executed by any computing system, for example, by the computer 102 of FIG. 1 or the system 202 of FIG. 2. The operations of the flowchart 600C may start at 618.

At 618, a difference between a token id of the different part of each of the first word 302A and the second word 302B. In an embodiment of the disclosure, the difference between the token id of the different part of each of the first word 302A and the second word 302B may be associated with the likelihood of the generation of the first candidate word by the AI model 204. In an embodiment of the disclosure, the likelihood of the generation of the first candidate word by the AI model 204 may increase corresponding to a difference between the token id of the different part of each of the first word 302A and the second word 302B. In an embodiment of the disclosure, the system 202 may be configured to determine the difference between the token id of the different part of each of the first word 302A and the second word 302B.

At 620, a determination is made whether the difference between the token id of the different part of each of the first word 302A and the second word 302B is less than the difference threshold or not. In an embodiment of the disclosure, the system 202 may be configured to determine whether the difference between the token id of the different part of each of the first word 302A and the second word 302B is less than the difference threshold or not. If the difference between the token id of the different part of each of the first word 302A and the second word 302B is not less than the difference threshold, then at 622, the system 202 may be configured to apply another criterion of the set of predefined criteria on the first candidate word from the first set of candidate words 208. In an embodiment of the disclosure, the system 202 may be configured to apply another criterion of the set of predefined criteria until the application of each criterion of set of predefined criteria on the first candidate word. Otherwise, the operations of the flowchart 600C may continue at 624 to generate the second set of candidate words 210.

At 624, the first candidate word is added to the second set of candidate words 210 based on a determination that the difference between the token id of the different part of each of the first word 302A and the second word 302B is less than the difference threshold. In an embodiment of the disclosure, the system 202 may be configured to add the first candidate word to the second set of candidate words 210 based on the determination that the difference between the token id of the different part of each of the first word 302A and the second word 302B is less than the difference threshold.

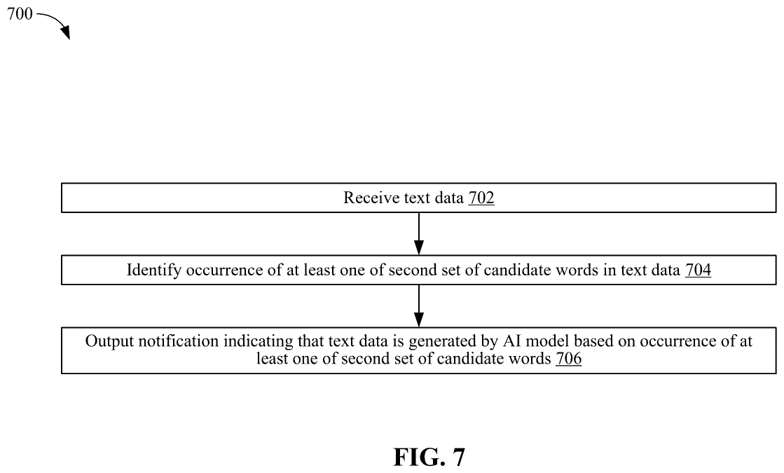

FIG. 7 is a flowchart 700 of a method for application of the sixth criterion on the first candidate word, in accordance with an embodiment of the disclosure. FIG. 6B is explained in conjunction with elements from FIG. 1, FIG. 2, FIG. 3A, FIG. 3B, FIG. 3C, FIG. 4, FIG. 5A, FIG. 5B, FIG. 5C, FIG. 6A, FIG. 6B, and FIG. 6C. The operations of the method depicted by the flowchart 700 may be executed by any computing system, for example, by the computer 102 of FIG. 1 or the system 202 of FIG. 2. The operations of the flowchart 700 may start at 702.

At 702, the text data is received. In an embodiment of the disclosure, the system 202 may be configured to receive the text data. In an embodiment of the disclosure, the system 202 may be configured to receive a text data as an input from the end user associated with the EUD 106. In an example embodiment of the disclosure, the end user may provide the text data to the system 202 to detect a plagiarism associated with generation of text data by the AI model 204. In another embodiment of the disclosure, the system 202 may be configured to receive the text data from a training dataset of the one or more ML models.

At 704, an occurrence of at least one of the second set of candidate words 210 in the text data is identified. In an embodiment of the disclosure, the system 202 may be configured to identify the occurrence of at least one of the second set of candidate words 210 in the text data.

At 706, a notification is output. In an embodiment of the disclosure, the system 202 may be configured to output the notification. The notification may be indicative of that the text data is generated by the AI model 204. The outputting is based on the occurrence of the at least one of the second set of candidate words 210 in the text data. In an embodiment of the disclosure, the system 202 may be configured to output the notification on the user interface associated with the system 202. In another embodiment of the disclosure, the system 202 may be configured to render an audio output indicative of the notification.

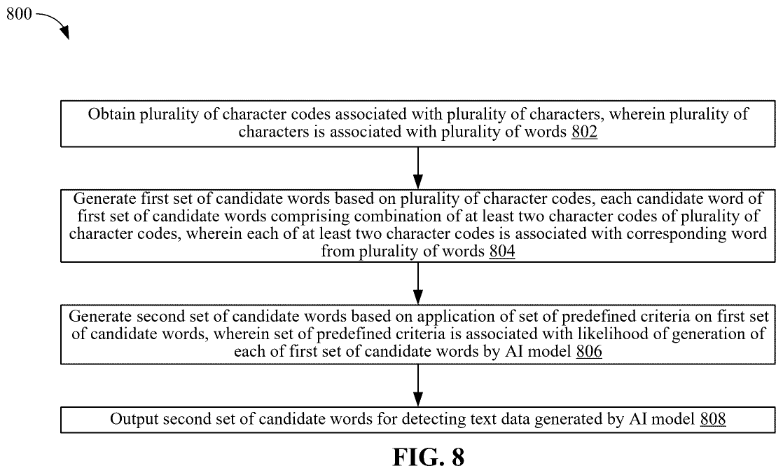

FIG. 8 is a flowchart 800 of a method for generation of the candidate words, in accordance with an embodiment of the disclosure. FIG. 8 is explained in conjunction with elements from FIG. 1, FIG. 2, FIG. 3A, FIG. 3B, FIG. 3C, FIG. 4, FIG. 5A, FIG. 5B, FIG. 5C, FIG. 6A, FIG. 6B, FIG. 6C and FIG. 7. The operations of the method depicted by the flowchart 800 may be executed by any computing system, for example, by the computer 102 of FIG. 1 or the system 202 of FIG. 2. The operations of the flowchart 800 may start at 802.

At 802, the plurality of character codes 216 associated with the plurality of characters 212 are obtained. In an embodiment of the disclosure, the system 202 may be configured to obtain the plurality of character codes 216 associated with the plurality of characters 212. Further, the plurality of characters 212 is associated with the plurality of words 214. Details about the acquisition of the plurality of character codes 216 are provided, for example, in FIG. 2.

At 804, the first set of candidate words 208 is generated based on the plurality of character codes 216. In an embodiment of the disclosure, the system 202 may be configured to generate the first set of candidate words 208 based on the plurality of character codes 216. Each candidate word of the first set of candidate words 208 may include a combination of at least two character codes of the plurality of character codes 216. Further, each of the at least two character codes is associated with a corresponding word from the plurality of words 214. Details about the generation of the first set of candidate words 208 are provided, for example, in FIG. 2.

At 806, the second set of candidate words is generated based on the application of the set of predefined criteria on the first set of candidate words 208. In an embodiment of the disclosure, the system 202 may be configured to generate the second set of candidate words 210 based on the application of a set of predefined criterion on each of first set of candidate words 208. The set of predefined criteria is associated with a likelihood of generation of each of first set of candidate words 208 by the AI model 204. Details about the generation of the second set of candidate words 210 based on the set of predefined criteria are provided, for example, in FIG. 2, FIG. 5A, FIG. 5B, FIG. 5C, FIG. 6A, FIG. 6B, and FIG. 6C.

At 808, the second set of candidate words is output for detecting the text data generated by the AI model 204. In an embodiment of the disclosure, the system 202 may be configured to output the second set of candidate words 210 for detecting the text data generated by the AI model 204. Details about the outputting of the second set of candidate words 210 are provided, for example, in FIG. 2.

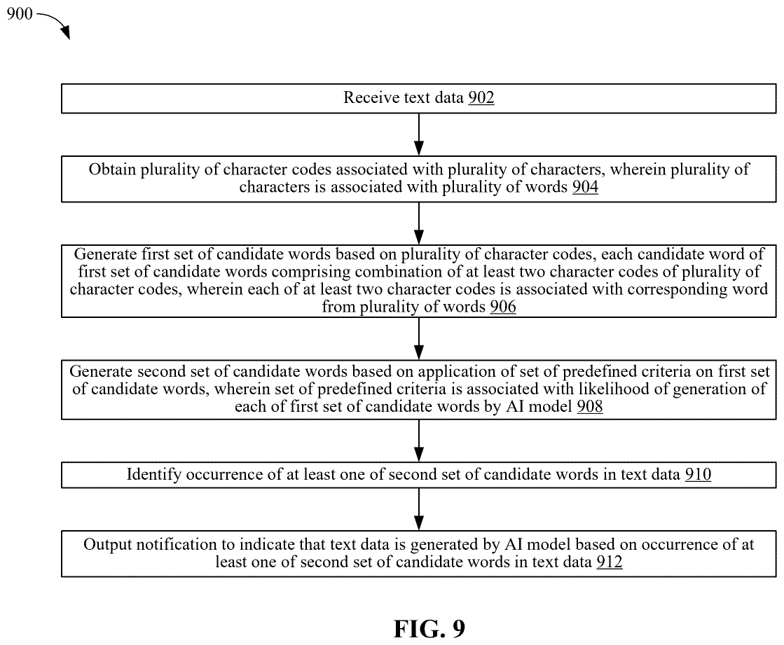

FIG. 9 is a flowchart 900 of a method for generation of the candidate words, in accordance with an embodiment of the disclosure. FIG. 9 is explained in conjunction with elements from FIG. 1, FIG. 2, FIG. 3A, FIG. 3B, FIG. 3C, FIG. 4, FIG. 5A, FIG. 5B, FIG. 5C, FIG. 6A, FIG. 6B, FIG. 6C, FIG. 7 and FIG. 8. The operations of the method depicted by the flowchart 900 may be executed by any computing system, for example, by the computer 102 of FIG. 1 or the system 202 of FIG. 2. The operations of the flowchart 900 may start at 902.

At 902, the text data is received. In an embodiment of the disclosure, the system 202 may be configured to receive the text data. Details about the acquisition of the text data are provided, for example, in FIG. 7.

At 904, the plurality of character codes 216 associated with the plurality of characters 212 are obtained. In an embodiment of the disclosure, the system 202 may be configured to obtain the plurality of character codes 216 associated with the plurality of characters 212. Further, the plurality of characters 212 is associated with the plurality of words 214. Details about the acquisition of the plurality of character codes 216 are provided, for example, in FIG. 2 and FIG. 8.

At 906, the first set of candidate words 208 is generated based on the plurality of character codes 216. In an embodiment of the disclosure, the system 202 may be configured to generate the first set of candidate words 208 based on the plurality of character codes 216. Each candidate word of the first set of candidate words 208 may include a combination of at least two character codes of the plurality of character codes 216. Further, each of the at least two character codes is associated with a corresponding word from the plurality of words 214. Details about the generation of the first set of candidate words 208 are provided, for example, in FIG. 2.

At 908, the second set of candidate words is generated based on the application of the set of predefined criteria on the first set of candidate words 208. In an embodiment of the disclosure, the system 202 may be configured to generate the second set of candidate words 210 based on the application of a set of predefined criterion on each of first set of candidate words 208. The set of predefined criteria is associated with a likelihood of generation of each of first set of candidate words 208 by the AI model 204. Details about the generation of the second set of candidate words 210 are provided, for example, in FIG. 2.

At 910, an occurrence of at least one of the second set of candidate words 210 in the text data is identified. In an embodiment of the disclosure, the system 202 may be configured to identify the occurrence of at least one of the second set of candidate words 210 in the text data.

At 912, a notification is output. In an embodiment of the disclosure, the system 202 may be configured to output the notification. The notification may be indicative of that the text data is generated by the AI model 204. The outputting is based on the occurrence of the at least one of the second set of candidate words 210 in the text data.

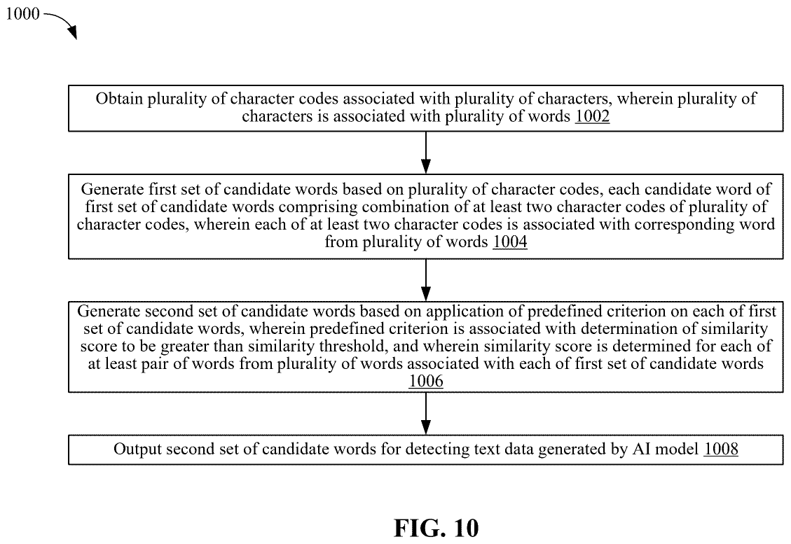

FIG. 10 is a flowchart 1000 of a method for generation of the candidate words, in accordance with an embodiment of the disclosure. FIG. 10 is explained in conjunction with elements from FIG. 1, FIG. 2, FIG. 3A, FIG. 3B, FIG. 3C, FIG. 4, FIG. 5A, FIG. 5B, FIG. 5C, FIG. 6A, FIG. 6B, FIG. 6C, FIG. 7, FIG. 8 and FIG. 9. The operations of the method depicted by the flowchart 1000 may be executed by any computing system, for example, by the computer 102 of FIG. 1 or the system 202 of FIG. 2. The operations of the flowchart 1000 may start at 1002.

At 1002, the plurality of character codes 216 associated with the plurality of characters 212 are obtained. In an embodiment of the disclosure, the system 202 may be configured to obtain the plurality of character codes 216 associated with the plurality of characters 212. Further, the plurality of characters 212 is associated with the plurality of words 214. Details about the acquisition of the plurality of character codes 216 are provided, for example, in FIG. 2 and FIG. 8.

At 1004, the first set of candidate words 208 is generated based on the plurality of character codes 216. In an embodiment of the disclosure, the system 202 may be configured to generate the first set of candidate words 208 based on the plurality of character codes 216. Each candidate word of the first set of candidate words 208 may include a combination of at least two character codes of the plurality of character codes 216. Further, each of the at least two character codes is associated with a corresponding word from the plurality of words 214. Details about the generation of the first set of candidate words 208 are provided, for example, in FIG. 2.

At 1006, the second set of candidate words is generated based on the application of the set of predefined criteria on the first set of candidate words 208. In an embodiment of the disclosure, the system 202 may be configured to generate the second set of candidate words 210 based on the application of a set of predefined criterion on each of first set of candidate words 208. The set of predefined criteria is associated with the determination of the similarity score to be greater than similarity threshold. The similarity score is determined for each of at least pair of words (such as the first word 302A and the second word 302B) from plurality of words 214 associated with each of first set of candidate words 208. Details about the determination of the similarity score are provided, for example, in FIG. 5C.

At 1008, the second set of candidate words is output for detecting the text data generated by the AI model 204. In an embodiment of the disclosure, the system 202 may be configured to output the second set of candidate words 210 for detecting the text data generated by the AI model 204. Details about the outputting of the second set of candidate words 210 are provided, for example, in FIG. 2.

Various embodiments of the disclosure may provide a non-transitory computer readable medium and/or storage medium having stored thereon, instructions executable by a machine and/or a computer to operate a system (e.g., the system 202) for generation of the candidate words. The instructions may cause the machine and/or computer to perform operations that include obtaining the plurality of character codes 216 associated with the plurality of characters 212. The operations further include generating the first set of candidate words 208 based on the plurality of character codes 216. Each candidate word of the first set of candidate words 208 may include a combination of at least two character codes of the plurality of character codes 216. Further, each of the at least two character codes is associated with a corresponding word from the plurality of words 214. The operations further include generating the second set of candidate words 210 based on the application of the set of predefined criteria on each of first set of candidate words 208. The set of predefined criteria is associated with the likelihood of generation of each of first set of candidate words 208 by the AI model 204. The operations further include outputting the second set of candidate words for detecting the text data generated by the AI model 204.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by a computer, a plurality of character codes associated with a plurality of characters, wherein the plurality of characters is associated with a plurality of words;
generating, by the computer, a first set of candidate words based on the plurality of character codes, each candidate word of the first set of candidate words comprising a combination of at least two character codes of the plurality of character codes, wherein each of the at least two character codes is associated with a corresponding word from the plurality of words;
generating, by the computer, a second set of candidate words based on an application of a set of predefined criteria on the first set of candidate words, wherein the set of predefined criteria is associated with a likelihood of generation of each of the first set of candidate words by an artificial intelligence (AI) model; and
outputting, by the computer, the second set of candidate words for detecting text data generated by the AI model.

2. The computer-implemented method of claim 1, further comprising:
receiving, by the computer, the text data;
identifying, by the computer, an occurrence of at least one of the second set of candidate words in the text data; and
outputting, by the computer, a notification indicating that the text data is generated by the AI model, wherein the outputting is based on the occurrence of the at least one of the second set of candidate words in the text data.

3. The computer-implemented method of claim 1, further comprising:
identifying, by the computer, a first word from the plurality of words, wherein the first word comprises a first character and a second character of the plurality of characters;
identifying, by the computer, a second word from the plurality of words, wherein the second word comprises the first character and a third character of the plurality of characters;
obtaining, by the computer, a first character code associated with the first character, a second character code associated with the second character and a third character code associated with the third character, wherein each of the first character code, the second character code and the third character code is one of the plurality of character codes; and
generating, by the computer, a potential candidate word for the first set of candidate words, based on the first character code and a combination of the second character code and the third character code.

4. The computer-implemented method of claim 3, wherein the potential candidate word comprises the first character and a fourth character of the plurality of characters, and wherein the fourth character is associated with a combination of a part of each of the second character code and the third character code.

5. The computer-implemented method of claim 3, further comprising:
comparing, by the computer, the potential candidate word with each of the plurality of words; and
adding, by the computer, the potential candidate word to the first set of candidate words based on a determination that each of the plurality of words is distinct from the potential candidate word.

6. The computer-implemented method of claim 1, further comprising:
applying, by the computer, the set of predefined criteria on a first candidate word from the first set of candidate words, the first candidate word being generated based on a first word and a second word from the plurality of words, and the first candidate word comprising a first part and a second part, wherein
the first part is associated with a common part of the first word and the second word,
the second part is associated with a combination of a different part of each of the first word and the second word, and
the first candidate word is associated with a set of first character codes of the plurality of character codes; and
adding, by the computer, the first candidate word to the second set of candidate words based on a determination that the first candidate word satisfies at least one predefined criterion of the set of predefined criteria.

7. The computer-implemented method of claim 6, wherein the set of predefined criteria comprises at least one of:
a first criterion associated with a determination that the common part corresponds to a starting part of each of the first word and the second word,
a second criterion associated with a determination that a usage of the second part of the first candidate word for a predefined time period is less than a threshold, and
a third criterion associated with a determination that a similarity score between the first word and the second word is greater than a similarity threshold.

8. The computer-implemented method of claim 6, wherein the set of predefined criteria is associated with tokenization of each of the plurality of characters, and wherein the set of predefined criteria further comprises at least one of:
a fourth criterion associated with a determination that a number of tokens associated with each of the first candidate word, the first word, and the second word is equivalent,
a fifth criterion associated with a determination that a token id associated with the second part of the first candidate word is within a predefined range, and
a sixth criterion associated with a determination that a difference between a token id of the different part of each of the first word and the second word is less than a difference threshold.

9. The computer-implemented method of claim 1, wherein the AI model is a large language model (LLM).

10. The computer-implemented method of claim 1, wherein each of the plurality of words is associated with a language, and wherein the language is at least one of Korean, Chinese, or Japanese.

11. A system, comprising:
a processor set configured to:
receive text data;
obtain a plurality of character codes associated with a plurality of characters, wherein the plurality of characters is associated with a plurality of words;
generate a first set of candidate words based on the plurality of character codes, each candidate word of the first set of candidate words comprising a combination of at least two character codes of the plurality of character codes, wherein each of the at least two character codes is associated with a corresponding word from the plurality of words;
generate a second set of candidate words based on an application of a set of predefined criteria on the first set of candidate words, wherein the set of predefined criteria is associated with a likelihood of generation of each of the first set of candidate words by an artificial intelligence (AI) model;
identify an occurrence of at least one of the second set of candidate words in the text data; and
output a notification to indicate that the text data is generated by the AI model, wherein the outputting is based on the occurrence of the at least one of the second set of candidate words in the text data.

12. The system of claim 11, wherein the processor set is further configured to:
identify a first word from the plurality of words, wherein the first word comprises a first character and a second character of the plurality of characters;
identify a second word from the plurality of words, wherein the second word comprises the first character and a third character of the plurality of characters;
obtain a first character code associated with the first character, a second character code associated with the second character and a third character code associated with the third character, wherein each of the first character code, the second character code and the third character code is one of the plurality of character codes; and
generate a potential candidate word for the first set of candidate words, based on the first character code and a combination of the second character code and the third character code.

13. The system of claim 12, wherein the potential candidate word comprises the first character and a fourth character of the plurality of characters, and wherein the fourth character is associated with a combination of a part of each of the second character code and the third character code.

14. The system of claim 12, wherein the processor set is further configured to:
compare the potential candidate word with each of the plurality of words; and
add the potential candidate word to the first set of candidate words based on determination of each of the plurality of words being distinct from the potential candidate word.

15. The system of claim 11, wherein the processor set is further configured to:
apply the set of predefined criteria on a first candidate word from the first set of candidate words, the first candidate word being generated based on a first word and a second word from the plurality of words, and the first candidate word comprising a first part and a second part, wherein
the first part is associated with a common part of the first word and the second word,
the second part is associated with a combination of a different part of each of the first word and the second word, and
the first candidate word is associated with a set of first character codes of the plurality of character codes; and
add the first candidate word to the second set of candidate words based on a determination that the first candidate word satisfies at least one predefined criterion of the set of predefined criteria.

16. The system of claim 15, wherein the set of predefined criteria comprises at least one of:
a first criterion associated with a determination that the common part corresponds to a starting part of each of the first word and the second word,
a second criterion associated with a determination that a usage of the second part of the first candidate word for a predefined time period is less than a threshold, and
a third criterion associated with a determination that a similarity score between the first word and the second word is greater than a similarity threshold.

17. The system of claim 15, wherein the set of predefined criteria is associated with tokenization of each of the plurality of characters, and wherein the set of predefined criteria further comprises at least one of:
a fourth criterion associated with a determination that a number of tokens associated with each of the first candidate word, the first word, and the second word is equivalent,
a fifth criterion associated with a determination that a token id associated with the second part of the first candidate word is within a predefined range, and
a sixth criterion associated with a determination that a difference between a token id of the different part of each of the first word and the second word is less than a difference threshold.

18. A computer program product for detection of text data generated by an artificial intelligence (AI) model, the computer program product comprising a computer-readable storage medium having program instructions embodied therewith, the program instructions executable by a system to cause the system to:
obtain a plurality of character codes associated with a plurality of characters, wherein the plurality of characters is associated with a plurality of words;
generate a first set of candidate words based on the plurality of character codes, each candidate word of the first set of candidate words comprising a combination of at least two character codes of the plurality of character codes, wherein each of the at least two character codes is associated with a corresponding word from the plurality of words;
generate a second set of candidate words based on an application of a predefined criterion on each of the first set of candidate words, wherein the predefined criterion is associated with determination of a similarity score to be greater than a similarity threshold, and wherein the similarity score is determined for each of at least a pair of words from the plurality of words associated with each of the first set of candidate words; and
output the second set of candidate words for detecting the text data generated by the AI model.

19. The computer program product of claim 18, wherein the program instructions executable by the system to cause the system to:
receive the text data;
identify an occurrence of at least one of the second set of candidate words in the text data; and
output a notification to indicate that the text data is generated by the AI model, wherein the outputting is based on the occurrence of the at least one of the second set of candidate words in the text data.

20. The computer program product of claim 18, wherein the program instructions executable by the system to cause the system to:
identify a first word from the plurality of words, wherein the first word comprises a first character and a second character of the plurality of characters;
identify a second word from the plurality of words, wherein the second word comprises the first character and a third character of the plurality of characters;
obtain a first character code associated with the first character, a second character code associated with the second character and a third character code associated with the third character, wherein each of the first character code, the second character code and the third character code is one of the plurality of character codes;
generate a potential candidate word for the first set of candidate words, based on the first character code and a combination of the second character code and the third character code;
compare the potential candidate word with each of the plurality of words; and
add the potential candidate word to the first set of candidate words based on a determination that each of the plurality of words is distinct from the potential candidate word.
